(19) United States
(12) Patent Application Publication
(10) Pub. No.: US 2026/0128696 A1
(43) Pub. Date: May 7, 2026

(54) NONLINEAR AND ADAPTIVE ALTERNATING-CURRENT SERVO ELECTRIC MOTOR ANGULAR POSITION CONTROL METHOD AND SYSTEM

(71) Applicant: TIANJIN SAIXIANG TECHNOLOGY CO., LTD, Tianjin (CN)

(72) Inventors: Xiaochen ZHANG, Tianjin (CN); Qiping CHU, Tianjin (CN); Jianhao ZHANG, Tianjin (CN)

(21) Appl. No.: 18/711,755

(22) PCT Filed: Apr. 11, 2022
(86) PCT No.: PCT/CN2022/086141

§ 371 Date: May 20, 2024

(30) Foreign Application Priority Data
Nov. 19, 2021 (CN) 202111383893.9

(51) Int. Cl. H02P 23/00; H02P 6/28

(52) U.S. Cl. CPC H02P 23/0077; H02P 6/28; H02P 23/0004; H02P 2205/01; H02P 2207/05

(57) ABSTRACT

A nonlinear and adaptive alternating-current servo electric motor angular position control method and system includes: acquiring original electric motor rotor angular position data; inputting the original electric motor rotor angular position data into a rotor angular position control module; performing second-order time differentiation on the electric motor rotor position data, so as to generate electric motor rotor angular acceleration data; inputting the electric motor rotor angular acceleration data and an output from the rotor angular position control module into an incremental inverse dynamic control module at the same time; and inputting the output from the incremental inverse dynamic control module into an electric motor current control module.

### FIELD

The present disclosure relates to motor control, and more particularly relates to a method and a system for nonlinear adaptive control of angular position of an AC servo motor.

### BACKGROUND

With constant advancements in smart technology, smart devices have been increasingly infiltrated in people's daily life, work, and study, contributing improved life quality and enhanced learning and work efficiency. In the field of motor control, a motor system is essentially nonlinear, time-varying, and uncertain, so that a nonlinear adaptive control algorithm is required in designing of its control system.

Currently, the traditional PID (Proportional, Integral, and Differential) control algorithm is generally adopted for the servo control system of all motors. However, the PID control algorithm is a linear system-oriented control algorithm, so that when the PID algorithm is used to control a nonlinear servo motor, a problem arises as to how to tune the proportional, integral, and differential parameters. Due to the nonlinearity, time-variation, and uncertainty of the motor system, it is essential to off-line or on-line identify the non-linear or linear motor and load models. The identified motor and load models are used for tuning the PID parameters instantly or by segments. The parameters of the traditional PID algorithm are constant throughout the control process, while in practical applications, the controlled system as a whole is unpredictable, so that invariant PID parameters cannot contribute a high-performance control effect to the system. Although a notable control effect can be achieved, model identification, particularly online model identification, also significantly increases system complexity; in addition, model identification cannot always guarantee correctness of the identified models or model parameters, so that an adaptive control system relying on this traditional PID algorithm can hardly be certified industrially. Other adaptive or smart control methods, such as fuzzy control, sliding mode control, neural network-based control, model reference adaptive control (MRAC), also have a problem of being unable to ensure algorithm stability or stable operation under any operating load.

By far, no effective solution has been provided to the problems noted supra yet.

### SUMMARY

Implementations of the disclosure provide a method and a system for nonlinear adaptive control of angular position of an AC servo motor to overcome the technical problems in conventional servo motor control technologies such as difficulties in identifying the motor model and the load model as well as tuning of time-varying parameters of the controller.

In one aspect of the disclosure, there is provided a method for nonlinear adaptive control of angular position of an AC servo motor, comprising:
obtaining angular position data of a rotor;
comparing the angular position data of the rotor with a desired angular position of the rotor, a difference of which being inputted to a rotor angular position control processing circuit;
taking a second-order time derivative of the angular position data of the rotor to generate angular acceleration data of the rotor;
inputting both of the angular acceleration data of the rotor and an output of the rotor angular position control processing circuit to an incremental dynamic inversion control processing circuit; and
inputting an output of the incremental dynamic inversion control processing circuit to a motor current control processing circuit.

The angular position data of the rotor is taken from a rotor rotating angle encoder.

The incremental dynamic inversion control processing circuit is expressed as:

$$Δ {i}_{q} = ( {i}_{q} - {i}_{q 0} ) = \frac{J}{p [ {ψ}_{m} - ( {L}_{q} - {L}_{d} ) {i}_{d} ]} ( {v}_{θ} - \frac{{d}^{2} θ}{{dt}^{2}} {\vert}_{0} )$$

where Δi_{q} denotes an increment of output current of the incremental dynamic inversion control processing circuit, i_{q} denotes an output current of the incremental dynamic inversion control processing circuit, i_{q0} denotes a preceding sample value of the output current of the incremental dynamic inversion control processing circuit, J denotes a rotational inertia, p denotes the number of magnetic poles of the motor, ψₘ denotes a magnetic flux of permanent magnet, L_{q} denotes a q-axis inductance, L_{d} denotes a d-axis inductance, i_{d} denotes a d-axis current, v_{θ} denotes virtual control variable in dynamic inversion control, and

$$\frac{{d}^{\text{?}} θ}{{dt}^{\text{?}}} {\vert}_{0}$$

$$\text{?} \text{indicates text missing or illegible when filed}$$

denotes a second-order time derivative of the angle of rotation of the rotor at the present sampling time.

Furthermore, control of the AC servo module further comprises: a motor current control processing circuit.

Another aspect of the disclosure further provides a nonvolatile memory medium, comprising a program stored, wherein the program, when running, controls a device hosting the nonvolatile memory medium to perform the method for nonlinear adaptive control of angular position of an AC servo motor.

A further aspect of the disclosure also discloses an electronic device, comprising a processor and a memory, a computer-readable instruction being stored in the memory, the processor being configured to run the computer-readable instruction, wherein the computer-readable instruction, when being executed, performs the method for nonlinear adaptive control of angular position of an AC servo motor.

In the implementations of the disclosure, by using a second-order time derivative (angular acceleration of the motor) of motor position instead of the motor system and load models, a need for system and load models is eliminated in dynamic inversion control, thereby overcoming the technical problems in conventional servo motor control technologies such as difficulties in identifying the motor model and the load model as well as tuning of time-varying parameters of the controller.

### BRIEF DESCRIPTION OF THE DRAWINGS

The drawings illustrated here are intended to facilitate understanding of the disclosure and constitute an integral part of the disclosure; schematic implementations and their descriptions provided herein only serve for explaining the disclosure, not constituting undue limitations to the disclosure. In the drawings:

FIG. 1 is a flow diagram of a method for nonlinear adaptive control of angular position of an AC servo motor according to some implementations of the disclosure;

FIG. 2 is a block diagram of a system for nonlinear adaptive control of angular position of an AC servo motor according to some implementations of the disclosure.

### DETAILED DESCRIPTION OF EMBODIMENTS

To facilitate those skilled in the art to understand the subject matter described herein, the technical solutions in some implementations of the disclosure will be described clearly and comprehensively with reference to the accompanying drawings. It is apparent that the implementations described herein are only part of the embodiments of the disclosure, not all of them. All other implementations derived by those skilled in the art based on the implementations described herein without exercise of inventive work shall fall within the protection scope of the disclosure.

It is noted that, the terms such as “first” and “second” referred to in the specification, claims, and drawings are used for distinguishing like objects, not necessarily used for describing a specific sequence or priority. It should be understood that features modified with such numerals may be exchanged with each other in appropriate circumstances, such that the implementations of the disclosure described herein can be carried out in a sequence not illustrated or described herein. In addition, the terms such as “comprise” and “have,” as well as any of their variants, are intent for a non-exclusive inclusion, e.g., a process, method, system, product, or apparatus comprising a series of steps or elements are not necessarily limited to those steps or elements explicitly limited herein, but may further comprise other steps or elements not explicitly limited herein or inherent to such a process, method, system, product or apparatus.

According to some implementations of the disclosure, there is provided a method for nonlinear adaptive control of angular position of an AC servo motor. It is noted that, the steps illustrated in the flow diagram in the accompanying drawings may be executed for example in a computer system with a set of computer-executable instructions; in addition, although a logic sequence is illustrated in the flow diagram, the illustrated or described steps may also be executed in a sequence different from what are described herein.

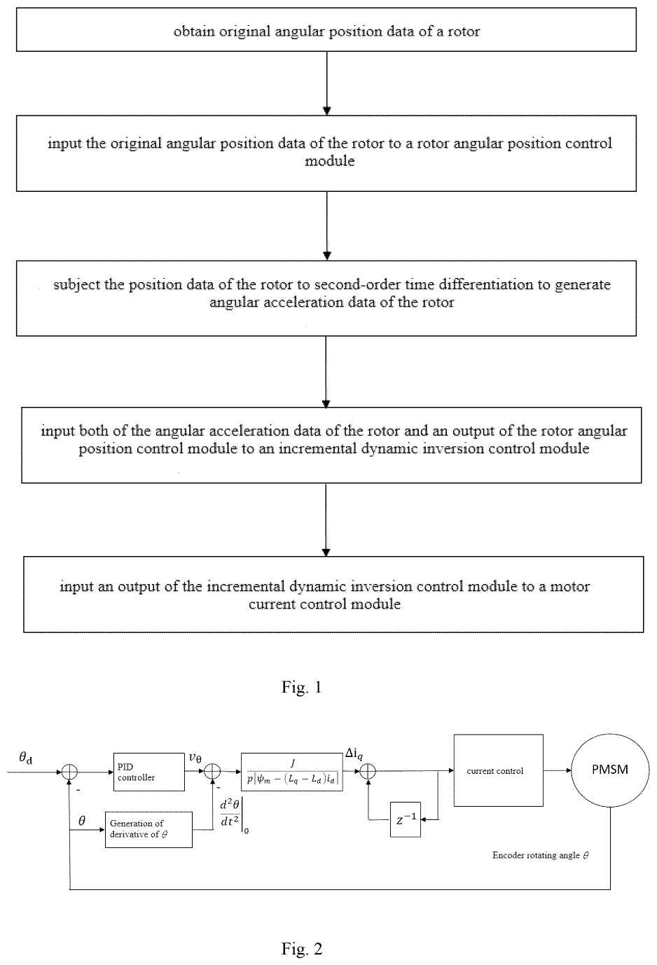

FIG. 1 is a flow diagram of a method for nonlinear adaptive control of angular position of an AC servo motor according to some implementations of the disclosure. As illustrated in FIG. 1, the method comprises steps below:
step S100, in which angular position data of a rotor is obtained;
step S200, in which the angular position data of the rotor is compared with a desired angular position of the rotor, and a difference thereof is inputted to a rotor angular position control module;
step S300, in which a second-order time derivative of the angular position data of the rotor is taken to generate angular acceleration data of the rotor;
step S400, in which the angular acceleration data of the rotor and an output of the rotor angular position control module are both inputted to an incremental dynamic inversion control module;
step S500, in which an output of the incremental dynamic inversion control module is inputted to a motor current control module.

FIG. 2 is a block diagram of a system for nonlinear adaptive control of angular position of an AC servo motor according to some implementations of the disclosure. As illustrated in FIG. 2, the system is configured to:
obtain angular position data of a rotor;
compare the angular position data of the rotor with a desired angular position of the rotor, and input a difference thereof to a rotor angular position control module;
take a second-order time derivative of the angular position data of the rotor to generate angular acceleration data of the rotor;
input both of the angular acceleration data of the rotor and an output of the rotor angular position control module to an incremental dynamic inversion control module; and
input an output of the incremental dynamic inversion control module to a motor current control module.

Specifically, the motor angular position control module has proportional, integral, and differential features.

The incremental dynamic inversion control module is given below:

$$Δ {i}_{q} = ( {i}_{q} - {i}_{q 0} ) = \frac{J}{p [ {ψ}_{m} - ( {L}_{q} - {L}_{d} ) {i}_{d} ]} ( {v}_{θ} - \frac{{d}^{2} θ}{{dt}^{2}} {\vert}_{0} )$$

where Δi_{q} denotes an increment of output current of the incremental dynamic inversion control module, i_{q} denotes the output current of the incremental dynamic inversion control module, i_{q0} denotes a preceding sample value of the output current of the incremental dynamic inversion control module, J denotes a rotational inertia, p denotes the number of magnetic poles of the motor, ψₘ denotes a magnetic flux of permanent magnet, L_{q} denotes a q-axis inductance, L_{d} denotes a d-axis inductance, i_{d} denotes a d-axis current, v_{θ} denotes a virtual control variable in dynamic inversion control, and

$$\frac{{d}^{2} θ}{{dt}^{2}} {\vert}_{0}$$

denotes a second-order time derivative of the angle of rotation of the rotor at a sampling point.

Specifically, the mathematic models in the example system for nonlinear adaptive control of angular position of an AC servo motor according to the disclosure include a current model, an angular speed model, and an angular position model, which, for example, may be given below:

### Current Model:

$$\frac{{di}_{d}}{d t} = \frac{1}{{L}_{d}} ( {u}_{d} - {Ri}_{d} + p {ω}_{m} {L}_{q} {i}_{q} ) \qquad ( 1 )$$

$$\frac{{di}_{q}}{dt} = \frac{1}{{L}_{q}} ( {u}_{q} - R {i}_{q} + p {ω}_{m} {L}_{d} {i}_{d} - p {ω}_{m} {ψ}_{m} ) \qquad ( 2 )$$

### Angular Speed Model:

$$\frac{d {ω}_{m}}{d t} = \frac{1}{J} \{ p {i}_{q} [ {ψ}_{m} - ( {L}_{q} - {L}_{d} ) {i}_{d} ] - B {ω}_{m} - {T}_{L} \} . \qquad ( 3 )$$

### Angular Position Model:

$$\frac{d θ}{dt} = {ω}_{m} \qquad ( 4 )$$

The variables and parameters in equations (1) to (4) are defined as follows: i_{d} and i_{q} denote d-axis and q-axis currents, respectively; L_{d} denotes the d-axis inductance; L_{q} denotes the q-axis inductance; ωₘ denotes the angular position of the rotor; p denotes the number of magnetic poles; T_{L} denotes an unknown load torque input; B denotes an unknown resistance coefficient; J denotes the rotational inertia; R denotes an unknown equivalent impedance; θ denotes the angle of rotation of the rotor; ψₘ denotes the magnetic flux of permanent magnet; and u_{d} and u_{q} denote the d-axis and q-axis control inputs, respectively.

The angular speed model (4) and the angular position model (5) may be combined as:

$$\frac{{d}^{2} θ}{{dt}^{2}} = \frac{1}{J} \{ {pi}_{q} [ {ψ}_{m} - ( {L}_{q} - {L}_{d} ) {i}_{d} ] - B \frac{d θ}{dt} - {T}_{L} \} . \qquad ( 5 )$$

It is noted that, a permanent-magnet synchronous motor (shortly PMSM) refers to a synchronous motor with its rotor using permanent magnet instead of winding. PMSM may be categorized into three types according to patterns of magnetic flux: axial flux, radial flux, and transverse flux. Dependent on layout of the elements therein, the various types of PSMSs are different in efficiency, size, weight, and operating speed. The operating principle of the PSMSs is same as an electrically excited synchronous motor, except that the PSMSs use the flux provided by the permanent magnet instead of being excited by an exciter field winding of the latter, whereby motor structure is simplified. The PMSM is a synchronous motor with a synchronous rotating magnetic field produced by permanent magnet excitation, where the permanent magnet serves as a rotor to produce a rotating magnetic field, and a three-phase stator winding induces three-phase symmetrical current via armature reaction under the action of the rotating magnetic field. Now, the dynamic energy of the rotor is converted to electrical energy, and the PMSM serves as a power generator; in addition, when the three-phase symmetrical current flows into the stator side, since the three-phase stator has a phase difference of 120° in terms of spatial position, the current of the three-phase stator generates a rotating magnetic field in the space; the rotor is subjected to an electromagnetic force to move in the rotating magnetic field, when the electrical energy is converted to dynamic energy, in which case the PMSM serves as a motor.

Due to presence of unknown parameters and inputs (B, R, T_{L}), the current model and the angular speed model are non-linear and uncertain, so that a linear system-oriented PID control cannot ensure a high performance. PID is an acronym for Proportional, Integral, and Differential. As the name suggests, the PID control algorithm is a control algorithm integrating proportion, integral, and differential phases, which is a technically mature and widely applied control algorithm for a continuous system. This control algorithm emerged in 1930s˜1940s, applicable to a scenario where the controlled object model is unknown. Both practical operation experience and theoretical analysis indicate that, for many industrial control processes, this control strategy can always achieve desirable results. PID control is essentially a calculation performed based on functional relationships between the proportional, integral, and differential algorithms using the deviation values inputted, the calculation result of which is used for output control. In addition, in PID control, the closed-loop control is a control mechanism that performs correction based on the feedback outputted by the controlled object, where the correction is made to the measured deviation between the actuality and the prediction according to a rated value or a criterion. For example, to control the rotating speed of a motor, a sensor is needed to measure the rotating speed and return the measurement to the control circuit. PID is one of the simplest closed-loop control algorithms. PID (Proportion, Integral, and Differential) represent three types of control algorithms, respectively. A combination of the three algorithms can effectively correct the deviation of controlled object, enabling the controlled object to reach a stable state.

The implementations of the disclosure achieve complete linearity based on the cascaded dynamic inversion control principle, eliminating a need of nonlinear dynamic and kinematic models required by dynamic inversion control. Specifically, the equation (5) is firstly expanded into Taylor series at the preceding time sample point, with its zero-order term and first-order term being taken as:

$${v}_{θ} = \frac{{d}^{2} θ}{{dt}^{2}} = \frac{{d}^{2} θ}{{dt}^{2}} {\vert}_{0} + \frac{1}{J} \{ p ( {i}_{q} - {i}_{q 0} ) [ {ψ}_{m} - ( {L}_{q} - {L}_{d} ) {i}_{d} ] - B ( \frac{d θ}{dt} - \frac{d θ}{dt} {\vert}_{0} ) - ( {T}_{L} - {T}_{L 0} ) \}$$

$$and$$

$${v}_{θ} = \frac{{d}^{2} θ}{{dt}^{2}} {\vert}_{0} + \frac{1}{J} \{ p Δ {i}_{q} [ {ψ}_{m} - ( {L}_{q} - {L}_{d} ) {i}_{d} ] - B ( \frac{d θ}{dt} - \frac{d θ}{dt} {\vert}_{0} ) - ( {T}_{L} - {T}_{L 0} ) \}$$

Under the high-speed sampling (equal to or higher than 10 kHz) which has been enabled for all servo motors:

$$p Δ {i}_{q} [ {ψ}_{m} - ( {L}_{q} - {L}_{d} ) {i}_{d} ] >> B ( \frac{d θ}{dt} - \frac{d θ}{dt} {\vert}_{0} ) - ( {T}_{L} - {T}_{L 0} )$$

the following can be obtained:

$${v}_{θ} = \frac{{d}^{2} θ}{{dt}^{2}} {\vert}_{0} + \frac{1}{J} \{ p Δ {i}_{q} [ {ψ}_{m} - ( {L}_{q} - {L}_{d} ) {i}_{d} ] \} .$$

By resolving Δi_{q}, an incremental dynamic inversion control is obtained:

$$Δ {i}_{q} = ( {i}_{q} - {i}_{q 0} ) = \frac{J}{p [ {ψ}_{m} - ( {L}_{q} - {L}_{d} ) {i}_{d} ]} ( {v}_{θ} - \frac{{d}^{2} θ}{{dt}^{2}} {\vert}_{0} ) \qquad ( 6 )$$

This outcome indicates that the control algorithm obtained by measuring the angle of rotation θ of the motor and calculating the time derivative

$$\frac{{d}^{2} θ}{{dt}^{2}} {\vert}_{0}$$

of the angle of rotation avoids the unknown impedance B and motor load T_{L} which are complex and uncertain. The time derivative, instead of the models, contributes adaptation to the dynamic inversion controller. Due to application of incremental control Δi_{q}, the angular position system of the motor is completely linearized and stabilized; since equation (5) is a two-order system, the dynamic inversion virtual control v_{θ} in Δi_{q} may be controlled by the apply invariable PID parameters:

$${v}_{θ} = {K}_{P θ} ( {θ}_{d} - θ ) + {K}_{I θ} \int ( {θ}_{d} - θ ) dt + {K}_{D θ} \frac{d ( {θ}_{d} - θ )}{d t} \qquad ( 7 )$$

where K_{Pθ}, K_{Iθ} and K_{Dθ} denote PID control coefficients, θ_{d} denotes a desired control value given by the user.

The equation (7) is P (Proportion) I (Integration) D (Differential) control in the classical control theory; it plays a role of controlling the error θ_{d}−θ of the motor angular position to minimal. By substituting the equation (7) into equation (6), a current control gain is produced, thereby producing the given value of the current control module (see FIG. 2).

The implementations of the disclosure offer the following benefits: 1. eliminating a need of adaptive control of the motor model; 2. non-linear control; 3. the control system is unsusceptible to uncertain system parameters; 4. the control system is unsusceptible to uncertain external disturbances; 5. the control system ensures closed-loop stability and high-performance control under any practical disturbing load; 6. the control algorithm is simple and easily implemented.

The implementations described supra overcome the technical problems in conventional servo motor control technologies such as difficulties in identifying the motor model and the load model as well as tuning of time-varying parameters of the controller.

The serial numbers of the implementations described supra are only for descriptive purposes, not representing priority of modified implementations.

The depictions of various implementations have different focuses, and some features not detailed in one implementation may refer to relevant depictions in other implementations.

In the various implementations provided herein, it should be understood that the technical contents disclosed herein may be implemented in other manners. The apparatus embodiments described supra are only schematic, e.g., partition of the units may be partition by logic functions; in practical implementation, the partition may have alternative partition manners, e.g., a plurality of units or components may be combined or integrated to another system, or some features may be omitted or may not be executed. Additionally, the mutual coupling, or direct coupling, or communication connection between what are displayed or discussed may be via some interfaces; the indirect coupling or communication connection between the units or modules may be of an electrical or otherwise form.

The units described as discrete parts may be or may not be physically separated; the parts displayed as units may or may not be physical units, i.e., they may be located at a same place or may be distributed on a plurality of units. Part or all of the units may be selected to achieve the objectives of the solutions in the implementations of the disclosure according to actual needs.

Additionally, various functional units in the implementations of the disclosure may be integrated on one processing unit, or may be physically existent standalone; or, two or more of the implemented above may be integrated on one unit. The integrated unit may be implemented in a hardware form or in a software functional unit form.

The integrated unit, if implemented in a software functional unit form and sold or used as a standalone product, may be stored in one computer-readable storage medium. Based on such understanding, the substantive technical solution of the disclosure, or the part contributing to the prior art, or all or part of the technical solution, may be embodied in a form of software product; the computer software product is stored in one storage medium, including a plurality of instructions to cause a computer device (which may be a personal computer, a server, or a network device) to execute all or part of the method described in various implementations of the disclosure. The storage medium includes various mediums that may store program code, such as a USB device, a ROM (Read-Only Memory), a RAM (Random Access Memory), a mobile hard disc, a magnetic disc, or an optical disc.

What have been described supra are only preferred implementations of the disclosure. It should be noted that, to a person of normal skill in the art, various alterations and modifications may also be made without departing from the principle of the disclosure, and such alterations and modifications should also be deemed as falling within the protection scope of the disclosure.

1. A method for nonlinear adaptive control of angular position of an AC servo motor, comprising:
obtaining angular position data of a rotor;
comparing the angular position data of the rotor with a desired angular position of the rotor, a difference of which being inputted to a rotor angular position control processing circuit;
taking a second-order time derivative of the angular position data of the rotor to generate angular acceleration data of the rotor;
inputting both of the angular acceleration data of the rotor and an output of the rotor angular position control processing circuit to an incremental dynamic inversion control processing circuit;
wherein the incremental dynamic inversion control processing circuit is expressed as:
$$Δ {i}_{q} = ( {i}_{q} - {i}_{q 0} ) = \frac{J}{p [ {ψ}_{m} - ( {L}_{q} - {L}_{d} ) {i}_{d} ]} ( {v}_{θ} - \frac{{d}^{2} θ}{{dt}^{2}} {\vert}_{0} )$$
where [symbol] _{q} denotes an increment of output current of the incremental dynamic inversion control processing circuit, i_{q} denotes an output current of the incremental dynamic inversion control processing circuit, i_{q0} denotes a preceding sample value of the output current of the incremental dynamic inversion control processing circuit, J denotes a rotational inertia, p denotes the number of magnetic poles of the motor, ψₘ denotes a magnetic flux of permanent magnet, L_{q} denotes a q-axis inductance, L_{d} denotes a d-axis inductance, i_{d} denotes a d-axis current, v_{θ} denotes a virtual control variable in dynamic inversion control, and
$$\frac{{\text{?}}^{\text{?}} \text{?}}{{\text{?}}^{\text{?}}} {\vert}_{\text{?}}$$
$$\text{?} \text{indicates text missing or illegible when filed}$$
denotes a second-order time derivative of the angle of rotation of the rotor at a sampling point; and inputting an output of the incremental dynamic inversion control processing circuit to
a motor current control processing circuit.

2. The method of claim 1, wherein the angular position data of the rotor is taken from a rotor rotating angle encoder.

3. A nonvolatile memory medium, comprising a program stored, wherein the program, when running, controls a device hosting the nonvolatile memory medium to perform the method according to claim 1.

4. An electronic device, comprising a processor and a memory, a computer-readable instruction being stored in the memory, the processor being configured to run the computer-readable instruction, wherein the computer-readable instruction, when being executed, performs the method according to claim 1.
